(19) United States
(12) Patent Application Publication
(10) Pub. No.: US 2018/0034646 A1
(43) Pub. Date: Feb. 1, 2018

(54) METHOD AND APPARATUS FOR SEAMLESS REMOTE RENEWAL OF OFFLINE GENERATED DIGITAL IDENTITY CERTIFICATES TO FIELD DEPLOYED HARDWARE SECURITY MODULES

(71) Applicant: ARRIS Enterprises LLC, Suwanee, GA (US)

(72) Inventors: Annie C. Kuramoto, San Diego, CA (US); Ting Yao, San Diego, CA (US); Jason A. Pasion, San Diego, CA (US); Jinsong Zheng, San Diego, CA (US); Fan Wang, San Diego, CA (US); Oscar Jiang, Rosemead, CA (US); Xin Qiu, San Diego, CA (US)

(21) Appl. No.: 15/661,880

(22) Filed: Jul. 27, 2017

Related U.S. Application Data
(60) Provisional application No. 62/367,638, filed on Jul. 27, 2016.

(51) Int. Cl. H04L 9/32; H04L 9/14; H04L 9/30; H04L 9/00

(52) U.S. Cl. CPC H04L 9/3268; H04L 9/006; H04L 9/14; H04L 9/30

(57) ABSTRACT

A method is provided for automatically renewing digital certificates in advance of their expiration in field deployed devices. The method includes generating a certificate renewal request comprising a request for at least one renewed digital certificate according to a renewal paradigm in which the at least one renewed digital certificate is generated before the at least one of the digital certificates expires, providing the certificate renewal request to the offline domain, obtaining, in the online domain from the offline domain, the at least one renewed digital certificate, and transmitting the least one renewed digital certificate to the client domain for storage in the HSM in place of the at least one of the subset of the plurality of digital certificates.

### CROSS-REFERENCE TO RELATED APPLICATIONS

This application claims benefit of U.S. Provisional Patent Application No. 62/367,638, entitled “METHOD OF SEAMLESS REMOTE RENEWAL OF OFFLINE GENERATED DIGITAL IDENTITY CERTIFICATES TO FIELD DEPLOYED HARDWARE SECURITY MODULES,” by Annie Kuramoto, Ting Yao, Jason Pasion, Jinsong Zheng, Fan Wang, Oscar Jiang and Xin Qiu, filed Jul. 27, 2016, which application is hereby incorporated by reference herein.

### BACKGROUND

### 1. Field of the Invention

The present invention relates to systems and methods for updating digital certificates, and in particular to a system and method for automatically renewing digital certificates in advance of their expiration in field deployed devices.

### 2. Description of the Related Art

In the era of information technology, Public Key Infrastructure (PKI) technology is widely adopted by organizations to implement security features in the products and services they provide. A well implemented PKI practice is often deeply involved in the organization's product development process, from the designing phase all the way to the manufacturing procedure.

A key part of the PKI practice is managing the life cycle of public key digital certificates (or just digital certificates)—An electronic document used to prove ownership of a public key. These digital certificates are distributed worldwide. The management of the digital certificates involves generation, distribution, renewing, expiring or revoking of these certificates.

The generation of digital certificates is frequently done in an offline network environment because it requires to be signed by a secret private key and that secret private keys are frequently kept offline for security purposes. To make PKI/digital certificate management seamless, a complex and customized process may be necessary. One of the more challenging part of this process is the certificate renewal process.

A primary property in a digital certificate is its validity period. It indicates the date from which the digital certificate is first valid from and when the digital certificate expires. Normally, when a digital certificate expires, it is no longer usable. Since certificates are often distributed all over the world and sometimes used offline, it is difficult to detect expiration and perform renewal on a timely, reliable manner.

Consider an exemplary security data and generation system used in conjunction with customer devices such as set top boxes (STBs) used to receive cable or satellite broadcasts. In the factory producing the STBs, a server may be implemented which hosts a database storing security/identity data used to configure the STBs. This server may be coupled to many client stations, which are used in the manufacture of the STBs. A STB in the making connects to one of the client stations, and requests security data from the database through the server and the client station. In order to assure that the data request is coming from a legitimate client station, and HSM token is plugged into the client station. The HSM token includes a digital certificate and a pairing private key tied to the client station using a unique identifier such as the client station's IP address. The server is similarly configured, with an analogous HSM token. Using the HSM tokens and data (e.g. the certificates and private keys), the client station and server can establish secure communications and communicate data (including the aforementioned security/identity data). The generation of the digital certificates for the HSM tokens used in this process is performed offline to render them more secure. Consequently, the generation of the renewed certificates is also accomplished offline.

In the foregoing electronic hardware device factory setting, the renewal of digital certificates is critical because they are required for mandated secure communications between the client station and the server. If digital certificates were to expire before renewal, the STBs could not retrieve the necessary security/identity data, leading to factory down time. Therefore, it is critical to start digital certificate renewal process prior to the digital certificate's expiration. However it is not feasible to simply rely on humans to keep track of expiration dates and renewals for thousands of digital certificates.

This scenario becomes even more complex in light of the fact that digital certificates can be stored on a hardware security module (HSM) token (a physical hardware device) that does not have network connectivity at all times. Consequently, an automated streamlined certificate renewal system/process becomes vital but challenging task, and having a streamlined digital certificate renewal process is crucial to the success of any Public Key Infrastructure.

### SUMMARY

To address the requirements described above, the present invention discloses a method and apparatus for renewing digital certificates. One embodiment, the method is implemented in a system including an online domain communicatively coupled to an offline domain and a client domain that remotely renews at least one of a subset of a plurality of digital certificates stored in a hardware security module (HSM) in the client domain, and the method includes generating a certificate renewal request including a request for at least one renewed digital certificate according to a renewal paradigm in which the at least one renewed digital certificate is generated before the at least one of the digital certificates expires; providing the certificate renewal request to the offline domain; obtaining, in the online domain from the offline domain, the at least one renewed digital certificate; and transmitting the at least one renewed digital certificate to the client domain for storage in the HSM in place of the at least one of the subset of the plurality of digital certificates. Other embodiments of this aspect include corresponding computer systems, apparatus, and computer programs recorded on one or more computer storage devices, each configured to perform the actions of the methods. In selected embodiments, the at least one renewed certificate includes a same subject name as that of the one of the subset of the plurality of digital certificates replaced by the at least one renewed certificate; and the at least one renewed certificate includes a same public key as that of the one of the subset of the plurality of digital certificates replaced by the at least one renewed digital certificate.

### BRIEF DESCRIPTION OF THE DRAWINGS

Referring now to the drawings in which like reference numbers represent corresponding parts throughout:

FIG. 1A is a diagram presenting an overview of the relationship architectural elements used in the certificate renewal process;

FIG. 1B presents a table summarizing primary embodiments of certificate renewal;

FIG. 2 is a diagram illustrating a generalized embodiment of the certificate renewal process;

FIGS. 3A-3C describe a first embodiment of a certificate renewal process;

FIG. 4 is a diagram describing another embodiment the certificate renewal process.

FIGS. 5A-5B are diagrams describe a further embodiment of a certificate renewal process;

FIGS. 6A-6B are diagrams describe a still further embodiment of a certificate renewal process;

FIGS. 7A and 7B are diagrams depicting a life cycle of an existing (current) digital certificate in the foregoing paradigm;

FIG. 8 is a sequence diagram describing the operation of the client SDK in the requesting of renewed (updated) digital certificates; and

FIG. 9 is a diagram illustrating an exemplary computer system that could be used to implement elements of the certificate renewal process.

### DETAILED DESCRIPTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

The system and method disclosed below provides an integrated solution that includes (1) the updating of certificates located worldwide from a central location remote from where the certificates are used (2) automatically detection of certificate expirations, (3) preemptive renewal of digital certificates prior to expiration and (4) keeping track of status of digital certificates.

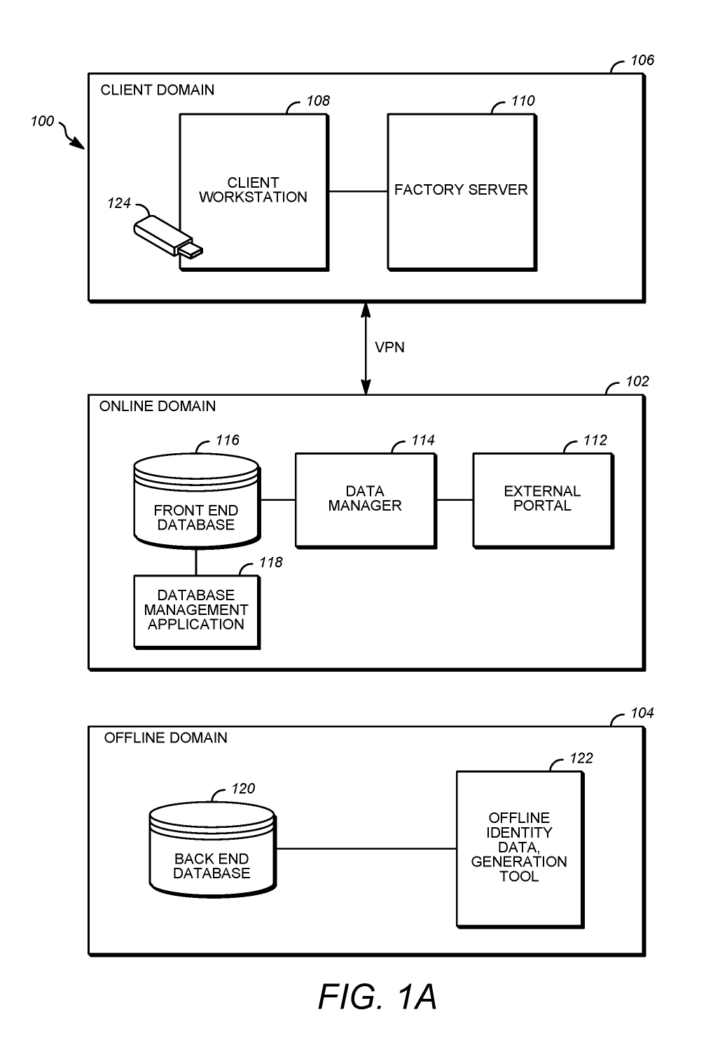

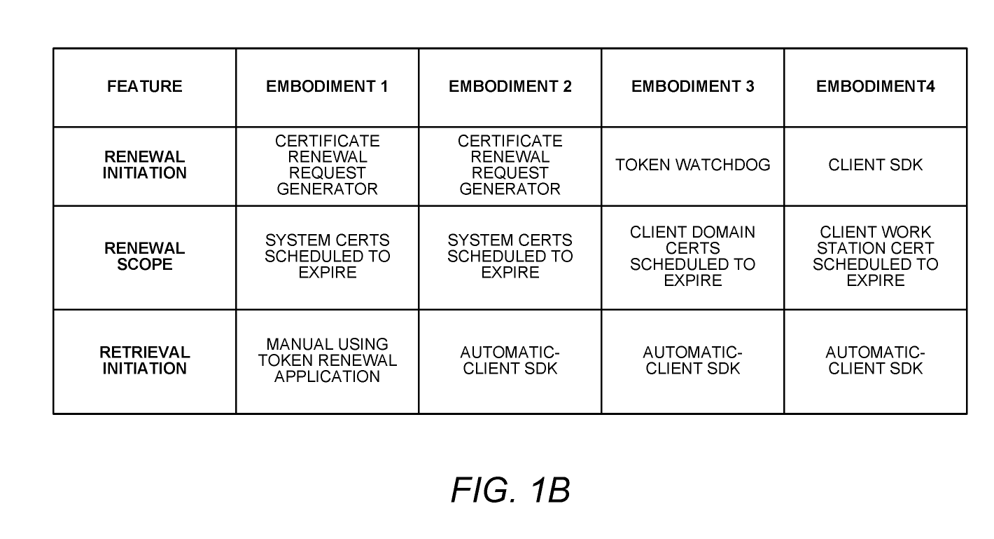

FIG. 1A is a diagram presenting an overview of the relationship of architectural elements used in the certificate renewal process. When a new cryptographic key pair (public and private key) is generated in the offline domain 104 using an offline identity data generation tool 122, a certificate is issued for the cryptographic key pair. This certificate is stored in the backend offline database 120 and an HSM token 124 personalized in the offline domain and later shipped to the field. The corresponding private key to the certificate is also stored in the HSM token 124. The status of this certificate is “active” while it is still within its validity period defined in the certificate. HSM tokens 124 which have been initialized with a private key and a certificate are then distributed to hardware devices such as client workstations 108 worldwide through an implementation of a Public Key Infrastructure (such as described in U.S. Pat. No. 9,043,456, hereby incorporated by reference herein) which includes a method of bringing the offline data to online status.

The backend database 120 retains certificate information such as the certificate itself, status of the certificate (active, revoked or expired), certificate's expiration and information of issuer of certificate. This information is also synchronized to a frontend database 116 by the means of a data synchronizer (such as is disclosed in U.S. Patent Publication 2008/0133543, hereby incorporated by reference herein). Thus the offline domain 104 and the online domain 102 both have certificates and status information. Since the offline domain 104 and the online domain have no network connection (they are typically air-gapped) the data in the offline domain 104 remains secure.

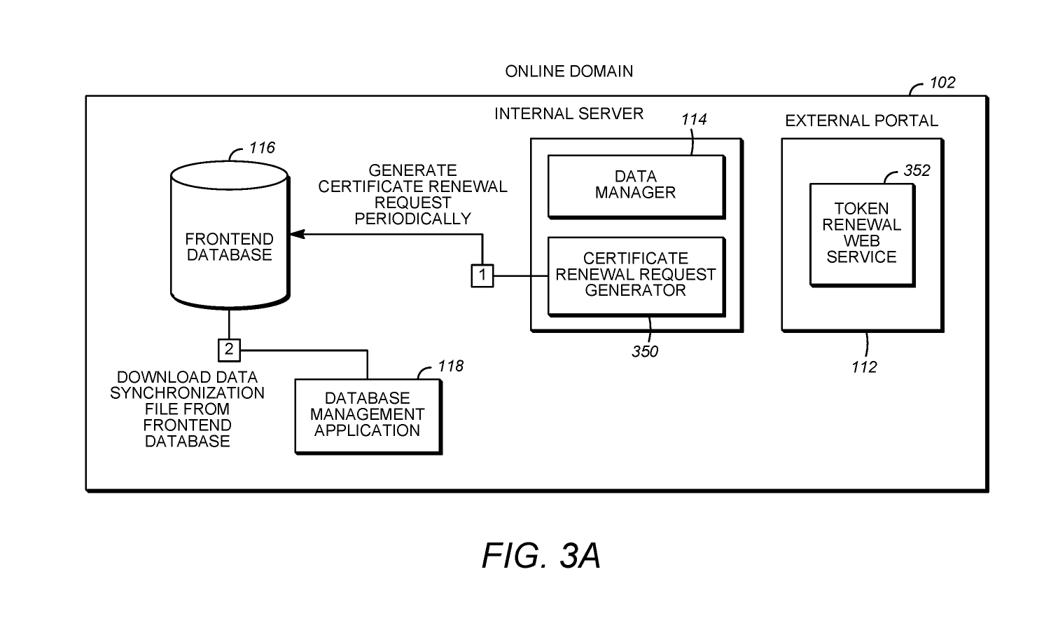

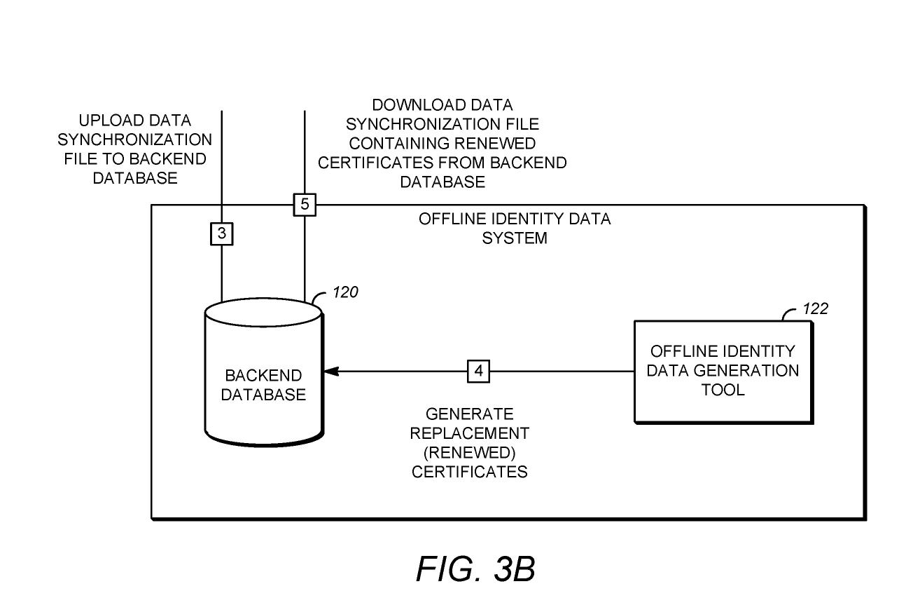

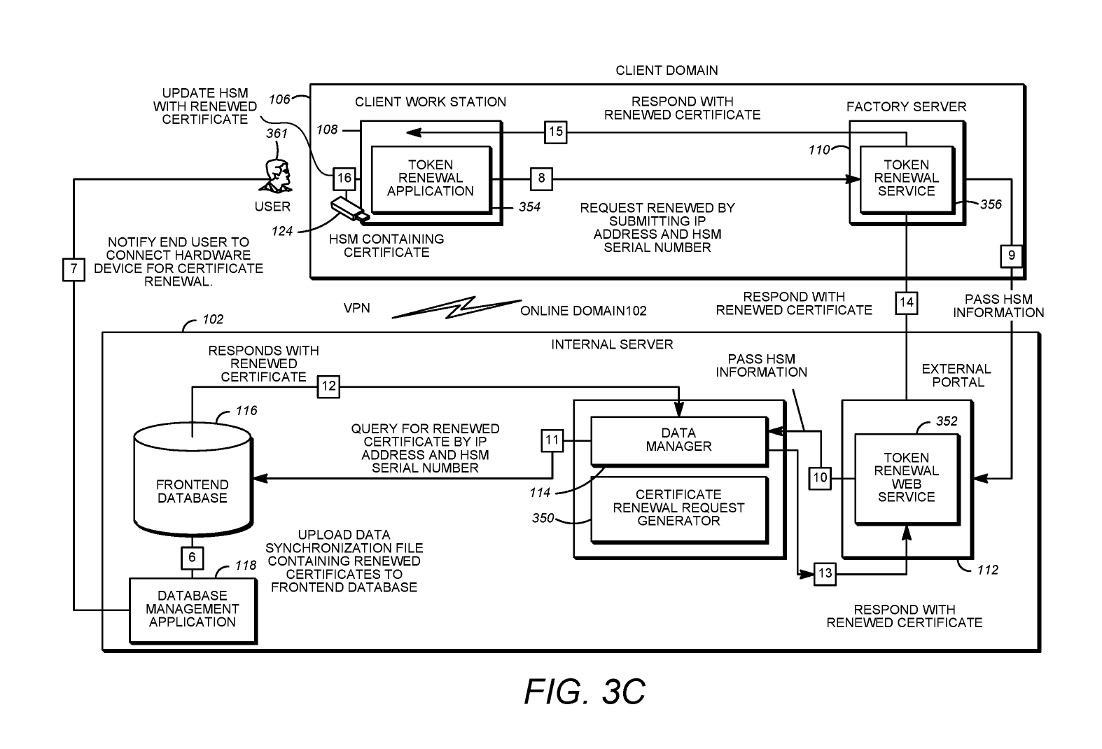

FIG. 1B presents a table summarizing the embodiments depicted in FIGS. 3A-6B and described below.

In a first embodiment, the generation of renewed certificates is initiated by a certificate request generator in the online domain. All of the certificates of the online domain meet the renewal paradigm (e.g. are scheduled to expire within a particular time period) are subject to the renewal process. The renewed certificates are retrieved manually, by a user of the client workstation, in response to a message or other prompt from the online domain, using the token renewal application.

In a second embodiment, the generation of renewed certificates also initiated by the certificate request generator in the online domain, and all of the certificates meeting the renewal paradigm are renewed. However, in this embodiment, the retrieval and installation of the renewed certificates at the client workstation is performed automatically by a client SDK

In a third embodiment, the generation of the renewed certificates is initiated by a token watchdog, executing in the client domain on the server. The token watchdog initiates renewal of all certificates for client workstations communicating with the server, which may include all such certificates used in the client domain. However, the number of certificates for which renewal is initiated is less than in the second embodiment, as only those certificates needed for the client domain associated with the token watchdog are included in the renewal request. Retrieval and installation of the renewed digital certificates is performed automatically by the client SDK.

In a fourth embodiment, the generation of the renewed certificates is initiated by the client SDK, and only those certificates needed by the client workstation are included in the renewal request. Hence, the number of certificates for which renewal is requested is less than the third embodiment. Retrieval and installation of the renewed certificates is performed automatically by the client SDK.

Certificate renewal requests are what triggers the process to generate renewal certificates. As described below, certificate renewal requests may originate in the online domain by the certificate renewal request generator, in a token watchdog, or in a client application executing on a client workstation in the client domain. In each case, the entity generating the certificate renewal request runs from time to time (or periodically) to generate the certificate renewal requests. The frequency and timing of the scheduled request is configurable.

The content of the certificate renewal request depends on the source of the request. In embodiments where the certificate renewal request is generated in the online domain by the certificate renewal request generator, the certificate renewal request includes a target date time for which all the certificates of the system 100 expiring prior to that date are requested to be renewed. In one embodiment, the target date time is set to the date of the next iteration of certificate renewal request is configured to fire, so that all certificates that are going to expire prior to the next certificate renewal trigger will have renewed certificates. In embodiments wherein the certificate renewal request is generated by a token watchdog of the client domain 106, the certificate renewal request includes a request for certificates that it has identified are scheduled to expire during the time period. In embodiments wherein the certificate renewal request is generated by an SDK executing at the client workstation, the certificate renewal request applies to only that certificate of the client workstation which is to be renewed.

Once the certificate renewal request is created, it is transferred to the offline certificate renewal facility or offline domain 104 by the data synchronizer. An offline identity data generation tool 122 then process the request by performing the following operations: (1) Iterate through active certificates, mark status of expired certificates as “Expired” if there is a renewed certificate to replace it from a previous renewal cycle. An expired certificate's status remains “active” if it does not have a renewed certificate to replace it. (2) Locate and renew all active certificates which are expiring prior to target renewal date. (3) Certificate renewal request generator service exports renewed certificates and certificate status updates to a synchronization file to be transferred to the online domain 102.

The synchronization file is then transferred to the online domain by data synchronizer. At this point, renewed certificates are available for updates at the device's discretion.

There are several different approaches available to retrieve and install renewed certificates. One method is to identify the original HSM token 124 requester/owner (this information is stored in the frontend database 116 at the time of request) and notify them of the expiring certificate, for example, via email or analogous means. Another method is to rely on the renewing certificate's signing CA attributes to identify a specific geographic location, and then using the geographic location to identify a group of individuals who can trigger the update. This method is a safer approach so that the renewal does not have a single point of failure.

In one embodiment, the HSM token 124 requesters/owners are responsible for connecting the HSM token 124 to a client work station 108 on a client domain 106 and a token renewal application (TRA) initiates the certificate replacement process. The TRA is an application that has access to the HSM token 124 and communicate with a token renewal service executing on the server 110. The TRA retrieves a unique identifier of the HSM 124 (for example, its serial number) then sends these attributes to the token renewal service. In one embodiment, the IP address is also used for renewal.

The token renewal service on the server 110 acts as a proxy between the client domain 106 and the token renewal web service in the online domain 102 (internet). The token renewal web service in the online domain 102 uses the HSM token's attributes sent from TRA to identify a renewed certificate from the frontend database 116 via the data manager 118 and relays the renewed certificate back to the client domain 106. The token renewal service in the client domain 106 relays the renewed certificate back to the client work station 108 where the HSM token 124 is connected.

Another more streamlined method is to build in certificate update checks and the token renewal application in the factory client software (or software development kit (SDK)) that uses the HSM token 124. When the HSM token is being used, the factory client software verifies the certificate's expiration. If the certificate is expired, the factory client software invokes the same procedures as the token renewal application to replace the HSM token's expired certificate with a renewed certificate.

Once the token renewal application receives the renewed certificate, it verifies the renewed certificate in a procedure that includes (1) verifying current date time falls within the validity period of the renewed certificate, (2) verifying the renewed certificate is newer than the original certificate by comparing its validity period, (3) verifying the renewed certificate has the same certificate issuer as the original certificate, (4) verifying the renewed certificate has the same subject attribute as the original certificate, (5) verifying the renewed certificate contains a valid certificate chain, (6) verifying, by signing a data blob with the HSM token's private key and verified with the renewed certificate's public key, and (7) verifying the HSM token 124 is functional after renewed certificate is loaded into the token.

The process in which the certificate renewal is completed prior to its expiration enables the HSM token to function seamlessly while the certificate renewal process takes place. A more detailed description of the process and embodiments is presented below.

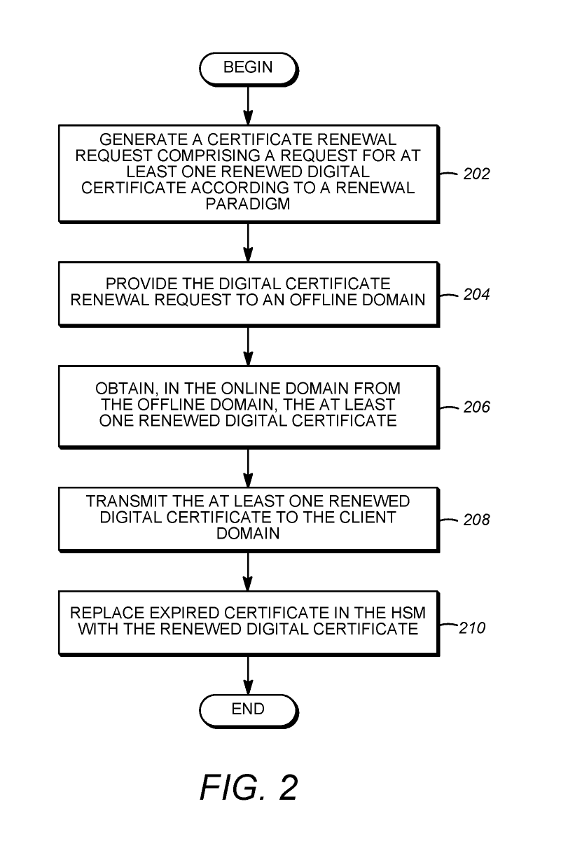

FIG. 2 is a diagram illustrating a generalized embodiment of the certificate renewal process. More specific embodiments are discussed in FIGS. 3A-6B.

Referring now to FIG. 2, block 202, generates a certificate renewal request comprising a request for at least one renewed digital certificate according to a renewal paradigm. In one embodiment, the renewal paradigm comprises renewing certificates that are scheduled to expire before the next scheduled certificate renewal request. This renewal paradigm permits those certificates to be renewed before they expire, thus preventing an interruption of services that require a valid and current digital certificate.

Block 204 provides the digital certificate renewal request to an offline domain 104 where the renewed digital certificates are generated. Block 206 obtains the at least one renewed certificate from the offline domain 104 in the online domain 102. In block 208, the at least one renewed digital certificate is transmitted to the client domain 106. Finally, in block 210, expired or expiring certificates in the HSM 124 are replaced with the renewed digital certificate.

FIGS. 3A-6B are diagrams further describing the primary embodiments of the system and method for renewing certificates and are further described below.

### First Embodiment: Certificate Renewal Trigged by Certificate Renewal Request Generator and Processed by a Token Renewal Application

FIGS. 3A-3C describe a first embodiment in which certificate renewal is triggered in the online domain 102 by a certificate renewal request generator 350 and transmitted to the offline domain 104. This certificate renewal request comprises information describing the renewal paradigm which has a temporal range of expiration dates of the plurality of digital certificates. The steps indicated in FIGS. 3A-3C by enclosed numbers are referred to in the text as simply “step N,” where N is the enclosed number. In step 1, the certificate renewal request generator 350 of the online domain 102 generates, from time to time, a certificate renewal request based on a renewal paradigm. The renewal paradigm may be such that the request is be generated periodically or aperiodically. For example, in one embodiment, the certificate renewal request is generated every temporal period T. The period T may be selected according to an expectation regarding how long it is expected for the renewal process to be completed. For example, in embodiments wherein user intervention is required to renew the certificates, the period T is selected to assure that a sufficient percentage of users will have received notification that renewed certificates are available and had the opportunity to install the renewed certificates before the current certificate expire. As another example, in embodiments wherein the certificate renewal process does not require user intervention, the time period T may be selected to assure that all of the renewed certificates are transmitted to the appropriate entities and installed before the expiring certificates expire. In other embodiments, the certificate renewal request is generated based upon a triggering event. For example, the certificate renewal request generator 350 may maintain a database of certificates, and generate a certificate renewal request when the owners of the originally issued certificates have requested renewal or when a particular number of certificates will require renewal over a particular time period.

In one embodiment, the certificate renewal request comprises information regarding the certificates must be renewed according to the renewal paradigm (e.g. certificates that are scheduled to expire within the time period Tin such embodiments), including information describing such certificates. The certificate renewal is saved into frontend database 116, which stores information on all current certificates of the online domain 102.

In step 2, the certificate renewal request is downloaded in the form of data synchronization file.

FIG. 3B illustrates exemplary operations performed in the offline domain 104. In step 3, the data synchronization file is uploaded to the backend database 120 of the offline domain. In step 4, the offline identity data generation tool 122 generates replacement (renewed) certificates, and provides the renewed certificates to the backend database 120 for storage. As described above, the offline identity data generation tool 122 generates the renewed certificates by: (1) iterating through active certificates, marking the status of expired certificates as “Expired” if there is a renewed certificate to replace it from a previous renewal cycle (an expired certificate's status remains “active” if it does not have a renewed certificate to replace it) (2) locating and renewing all active certificates which are expiring prior to target renewal date, and (3) exporting renewed certificates and certificate status updates to a synchronization file to be transferred to the online domain 102. In step 5, the renewed certificate is downloaded in the form of data synchronization file from the backend database 120 to the frontend database 116 by the data management application 118.

FIG. 3C is a diagram illustrating exemplary operations performed in the online domain 102. In step 6, an admin uses the database management application 118 to upload the data synchronization file containing the renewed certificates to the frontend database 116. In step 7 (which may be performed concurrently with step 6), the end users 361 are provided a notification that one or more renewed certificates for the HSM 124 are available and to connect the HSM 124 to the client workstation 108 to run Token Renewal Application so that the renewed certificate(s) may be stored by the HSM 124.

In step 8, the user 361 uses a token renewal application 354 executed by the client workstation 108 to generate a request for a renewed token. The token renewal application is described in greater detail below.

In the illustrated embodiment, the request for a renewed token comprises an identifier of the HSM 124 or HSM ID (e.g. the serial number of the HSM 124) and an IP address of the client workstation 108. The request for a renewed token is transmitted to a token renewal service 356 executing on a server 110, which services the client work station 108 (and optionally, a plurality of client work stations 108 in the client domain 106). In step 9, the token renewal service 356 passes the HSM ID and the IP address to an external portal 112 of the online domain 102 executing a token renewal web service 352). In step 10, the token renewal web service 352 passes the HSM ID and the IP address to the data manager 114. The data manager 114 generates a query for the requested renewed certificate(s) using the IP address and the HSM ID, and queries the frontend database 116 for renewed certificates responsive to this information. In step 12, the frontend database 116 identifies with renewed certificate(s) that are responsive to the query (to find renewed certificates associated with the IP address and HSM ID), and responds to the data manager 114 with these renewed certificate(s). In step 13, the data manager 114 provides these renewed certificates to the token renewal web service 352 executing on the external portal 112 of the online domain 102.

In step 14, the renewed certificate(s) are provided to the token renewal service 356 executed by the server 110, and in step 15, the token renewal service provides the renewed certificates to the token renewal application 354 executing in the client workstation 108. Finally, in step 16, the user 361 installs the renewed certificate(s) by using the token renewal application 354 to verify the certificate and store it in the HSM 124 using the token renewal application 354. This process includes (1) verifying current date time falls within the validity period of the renewed certificate, (2) verifying the renewed certificate is newer than the original certificate by comparing its validity period, (3) verifying the renewed certificate has the same certificate issuer as the original certificate, (4) verifying the renewed certificate has the same subject attribute as the original certificate, (5) verifying the renewed certificate contains a valid certificate chain, (6) verifying by signing a data blob with the HSM token's private key and verified with the renewed certificate's public key, and (7) verifying the HSM token 124 is functional after renewed certificate is loaded into the token. This verification process is also performed in the second, third, and fourth embodiments described below.

### Second Embodiment: Certificate Renewal Triggered by Certificate Renewal Generator and Processed by Client SDK

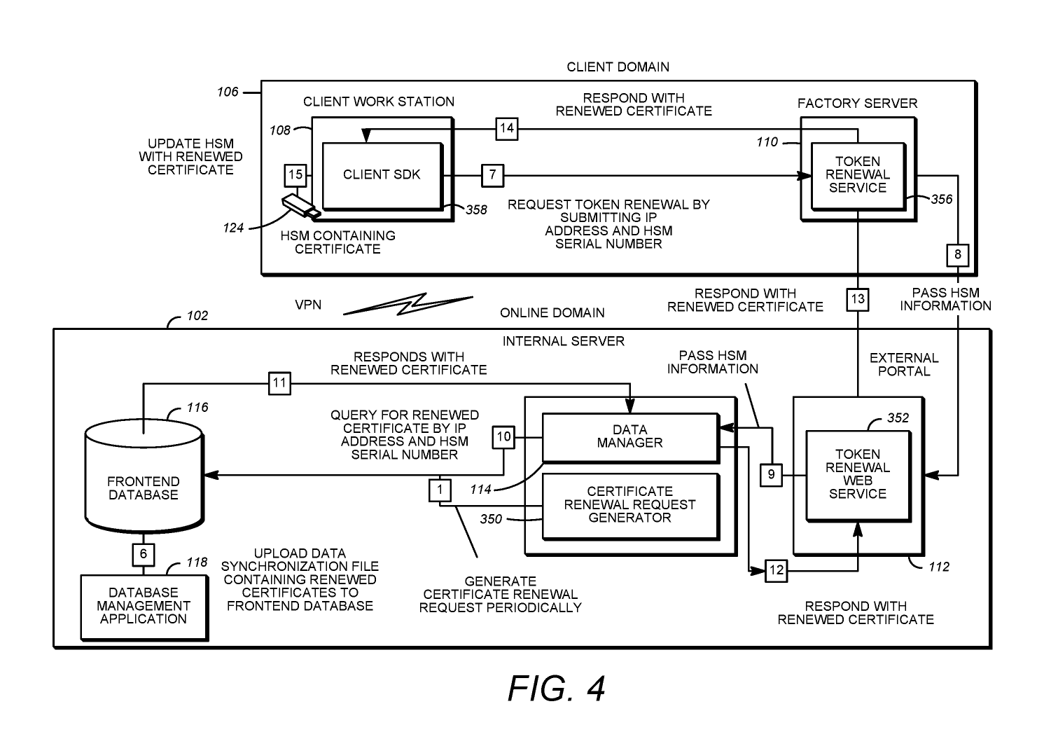

FIG. 4 is a diagram describing another embodiment of the renewal of certificates. In this embodiment, the generation of renewed certificates is triggered by the certificate renewal generator in the online domain as was the case in the previous embodiment, but certificates are automatically requested and installed by a software development kit (SDK) 358 executing on the client workstation 108, thus obviating the need for any human intervention in the process. The embodiments operate analogously with respect to the generation of renewed certificates, and differ with respect to how the renewed certificate is transmitted to the client domain 106 for storage in the HSM 124.

The primary task of the SDK 358 is to setup and maintain the secure communication between the client work station 108 and server 110 with transport layer security (TLS) and signed messages, using security objects stored in the HSM 124. In this embodiment, the SDK 358 also checks the client workstation 108 and HSM 124 for certificates that are scheduled to expire. This can be accomplished, for example, during TLS session initialization phase. Since the certificate check is integrated with the SDK 358, certificates in need of renewal are identified and renewed certificates are be installed (e.g. stored on the HSM 124) automatically (e.g. without human intervention) and without the need to notify users that renewed certificates are available for installation, as was the case in the first embodiment.

Steps 1-6 are analogous to steps 1-6 described in FIGS. 3A-3C described above. However, in this embodiment, there is no need to transmit a notification to users of the client work station 108 to attach the HSM and initiate installation of the renewed certificate(s). Instead, in step 7, the SDK 358 determines that certificates stored in the HSM 124 subject to the renewal paradigm (e.g. are scheduled to expire within a time period that may be set by the user using the SDK), and the SDK 358 initiates the process of retrieving renewed certificates to replace those certificates that are scheduled to expire. In the illustrated embodiment, following this determination, the SDK 358 transmits information requesting renewed certificates to a token renewal service 356 executing on the server 110. In one embodiment, this information includes the IP address of the client workstation 108 and the HSM ID. The token renewal service 356 receives this information and passes it along to a token renewal web service 352 executing in an external portal 112 of the online domain 102. Thereafter, the online domain 102 responds as it did in the previous embodiment, passing the HSM ID and IP address to the data manager 114, which retrieves the renewed certificate(s) from the frontend database 116 and provides those certificate(s) to the token renewal service 356 executed by the server 110 via the token renewal web service 352 executing in the external portal 112 of the online domain 102. In this embodiment, the token renewal service 356 provides the renewed certificate(s) to the SDK 358, and the SDK 358 updates the certificates that were scheduled to expire by replacing such certificates with the renewed certificates received from the token renewal service 356.

### Third Embodiment: Certificate Renewal Triggered by Token Watchdog in Client Domain

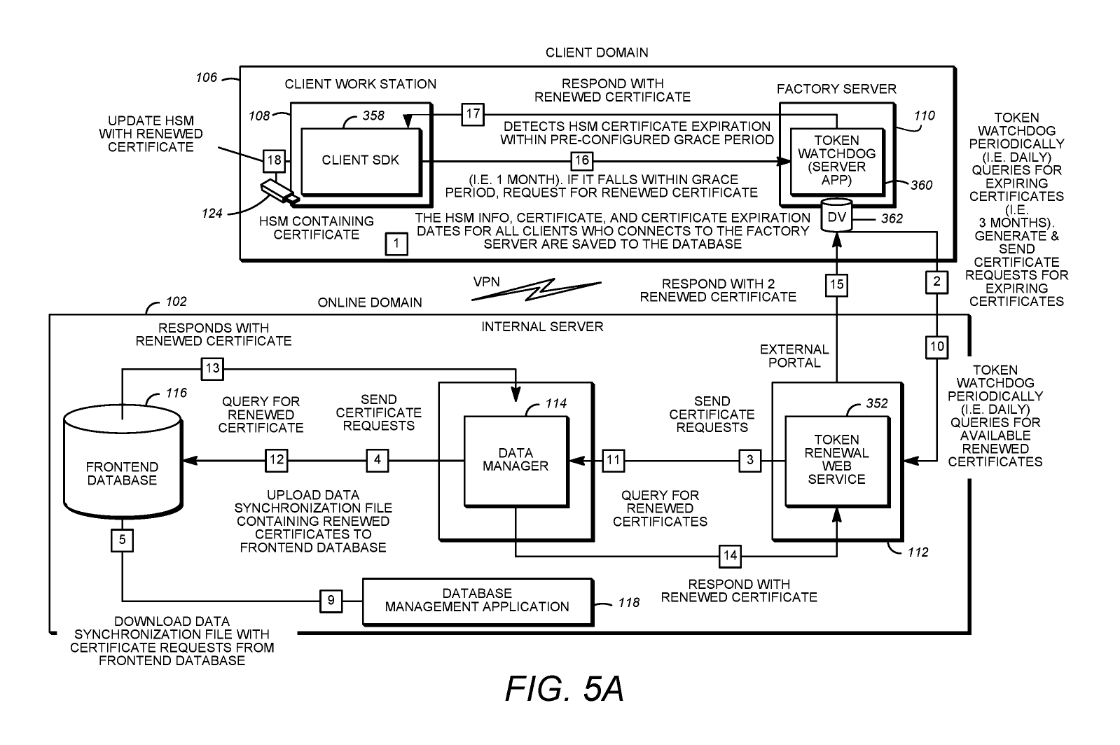

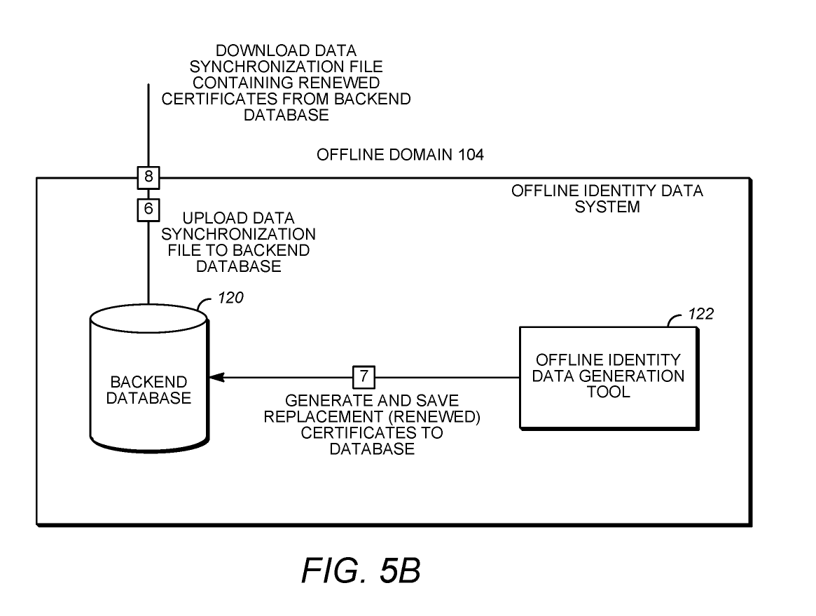

FIGS. 5A-5B are diagrams illustrating another embodiment of a certificate renewal process. Unlike the two previous embodiments, the certificate generation is triggered by a token watchdog—a software component executing on the server 110 with access to a database 362 having information required to initiate the renewal of the certificates in HSMs 124 of client workstations 108 that connect to the server 110. Such information may include, for example, HSM information including the HSM ID, identifying information for each of the certificate(s) stored on such HSMs 124, the expiration date and/or status of each such certificate(s), the existing certificates themselves, and the renewed certificates themselves when obtained from the online domain 102.

The token watchdog 360 checks its database 362 and triggers a certificate generation request for the existing certificates scheduled to expire. This request contains specific information about the certificates not just the temporal range of expiration dates as in the previous two embodiments. The number of certificates in the request is also determined and specified in the request. The request is provided to the online domain 102, which directs the offline domain 104 to generate renewed certificates. The token watchdog 360 then retrieves the newly generated renewed certificates back to its database 362. After certificates are replaced by renewed certificates, the database 362 is updated to reflect the information of the renewed certificates, and the renewed certificates are available to the SDK 358 for installation on the HSM 124.

When an SDK 358 detects the certificate in the HSM 124 is scheduled to expire within an time period, the SDK 358 retrieves the required renewed certificate from the token watchdog database 362 rather than the online domain 102, as was the case in previous embodiments. Since the token watchdog database 362 is in the same domain as the client workstation 108, this affords improved response time and assures that renewed certificates will be available, even if access to the online domain 102 is temporarily unavailable.

Referring first to FIG. 5A, in step 1, certificate renewal information is stored in the token watchdog database 362. Such certificate renewal information may include, for example, the HSM ID of each HSM 124 associated with each client workstation 108 communicating with the server 110, identifying information for each of the certificate(s) stored on such HSMs 124, the expiration date and/or conditions of each such certificate(s), and the renewed certificates themselves when obtained from the online domain 102. In step 2, the token watchdog 360 queries the token watchdog database 362 to identify certificates scheduled to expire within a time period, and sends request to renew each identified expiring certificate to the token renewal web service 352 executing in an external portal 112 of the online domain 102. This can be performed periodically (e.g. daily), aperiodically, or upon the occurrence of defined events (e.g. when bandwidth permits). In step 3, the token renewal web service sends these certificate requests to the data manager 114, which, in step 4, forwards the certificate request to the frontend database 116. In step 5, the database management application 118 downloads a data synchronization file with the certificate requests from the frontend database 116 to the offline domain 104.

Referring now to FIG. 5B, the data synchronization file with the certificate requests is uploaded to the backend database, as shown in step 6. In step 7, the offline identity data generation tool 122 generates renewed certificates to replace those which have been identified as about to expire, and saves those renewed certificates to the backend database 120 in the synchronization file. Note that unlike the previous two embodiments, this embodiment requires only those certificate identified by the token watchdog 360 to be renewed. This involves only client workstations 108 serviced by the server 110 (and does not include certificates for entities outside of the client domain 106 such as other clients), so the offline identity data generation tool 122 is not required to generate as many renewed certificates. Also, since the token watchdog 260 identifies the certificates to be updated, this task need not be performed by other elements, such as the offline identity data generation tool 122 and the certificate renewal request generator 350.

Returning again now to FIG. 5A, in steps 8 and 9, the synchronization file containing the renewed certificates is downloaded from the backend database 120 to the frontend database 116 via the database management application 118. The renewed certificates are now available to be provided to the token watchdog 360 upon request.

In step 10, the token watchdog 360 queries for renewed certificates that are available from the online domain 102. Typically, this query is limited to those renewed certificates for which the token watchdog 360 had previously requested renewed certificates. The token renewal web service 352 receives this query and provides a query for renewed certificates to the data manager 114, as shown in step 11. The data manager 114 provides the query for renewed certificates to the frontend database 116, as shown in step 12.

The frontend database 116 response to the query from the data manager 114 with renewed certificates that are available and responsive to the token watchdog's earlier request for renewed certificates, as shown in step 13. As shown in step 14, the data manager 114 then responds to the token renewal web service 352 with the renewed certificates responsive to the query described in step 11. In step 15, the renewed certificates are sent from the token renewal web service 352 to the token watchdog 360 for storage in the token watchdog database 362. Further, as additional client workstations 108 or additional HSMs 124 are added to the client domain 106, the database 363 is updated to reflect this information as well.

Like the previous embodiment, the SDK 358 detects which certificate(s) are scheduled to expire, and requests renewed certificates for those that are about to expire. However, instead of requesting such renewed certificates from the online domain 102, the renewed certificates are obtained from the token watchdog database 362. Hence, in step 16, the SDK 358 detects which certificates are to expire within a time period (e.g. a grace period pre-configured in the SDK 358 or specified by the user of the client workstation 108. If the expiration date of a certificate stored in the HSM 124 is within the grace period, the SDK 358 generates a request for a renewed certificate to replace the expiring certificate and provides the request to the token watchdog 360 executing on the server. In step 17, the token watchdog obtains the certificate from the token watchdog database 362 and transmits the renewed certificate to the SDK 358, and in step 18, the SDK 358 installs the renewed certificate in the HSM 124. Importantly, the foregoing steps can be configured to be performed automatically and without user intervention.

### Fourth Embodiment: Certificate Renewal Triggered by Client SDK

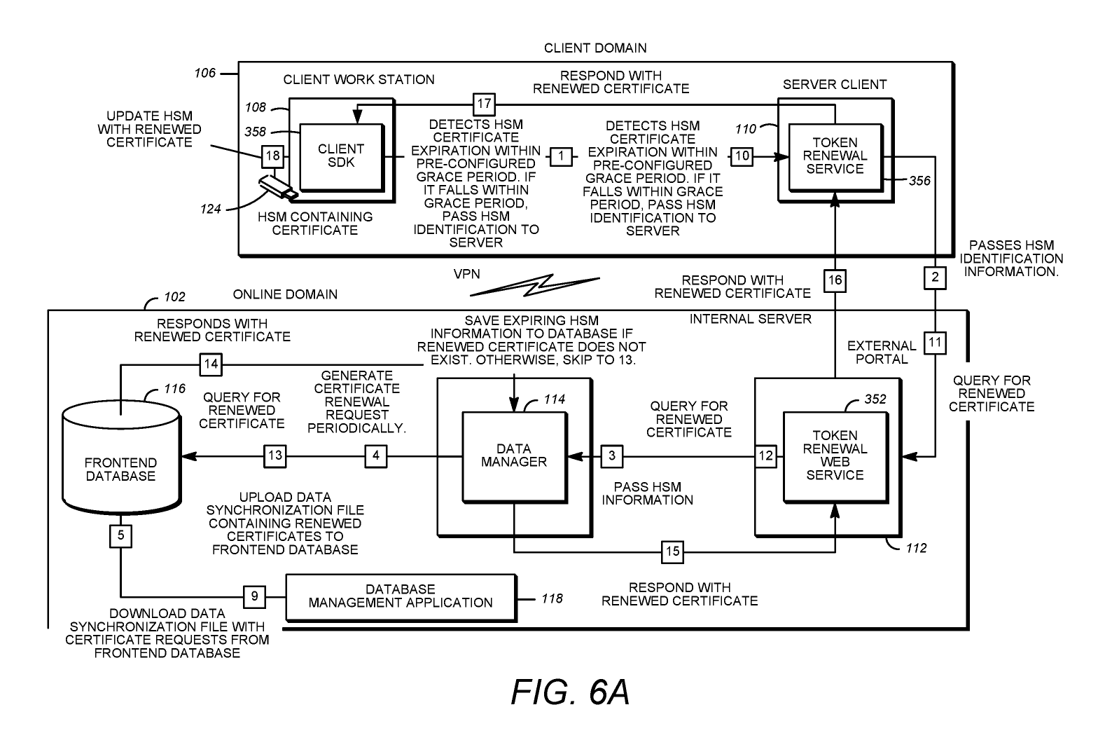

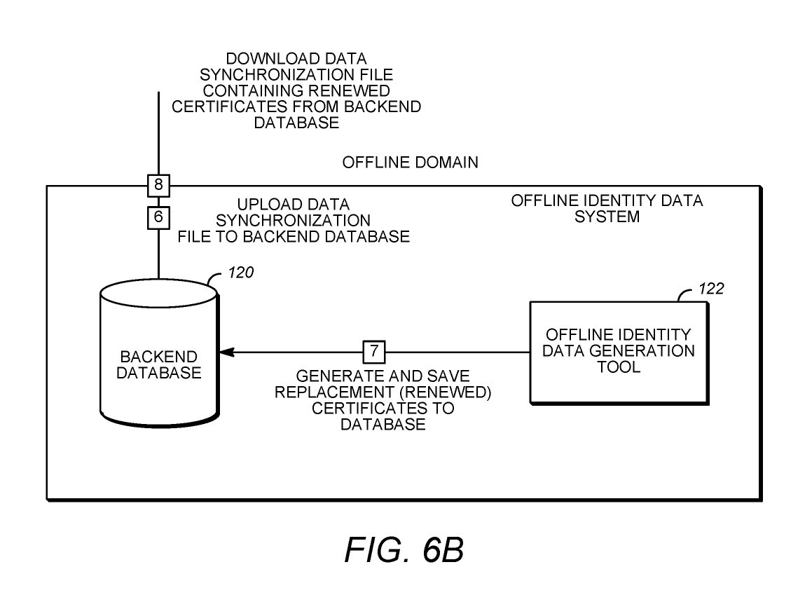

FIGS. 6A-6B are diagrams illustrating another embodiment of a certificate renewal process. This embodiment does not include a token watchdog 360 and instead includes the token renewal service 356 of the first two embodiments. Since there is no token watchdog 360, the certificate generation request is triggered by the client SDK 358 and renewed tokens are not stored locally in the client domain 106 (e.g. in the token watchdog database 362). Instead, the renewed certificates are requested when directed by the client SDK 358. Further, unlike the second embodiment wherein the renewed certificates are generated in the offline domain 104 in advance and stored in the frontend database 116 under direction of the certificate renewal request generator 350, in this embodiment, the requested renewed certificate is obtained from the backend database of the offline domain 104 in response to the request for the renewed certificate. Since the certificate generation request is triggered by client SDK 358 and the certificate is generated in response to that request and not stored in the client domain 106, there is an increased chance for client downtime because the certificate may expire before the replacement certificate is generated and ready for renewal (in step 10-13). However, this case does provide a way for re-key renewal (i.e. create a new key pair in the token by client SDK in step 1, and send a certificate signing request which contain the new public key in step 1-4). Further, any delays may be reduced by configuring the SDK 358 to request renewed certificates in further in advance than the other embodiments.

Referring now to FIG. 6A, in step 1, the SDK 358 determines which certificates stored in the HSM 124 will expire according to the renewal paradigm. In one embodiment, this comprises the digital certificates that will expire within a user-specified or pre-configured period of time or digital certificates which have expired, but are subject to a grace period. The identity of such certificates and the HSM ID is then provided to the token renewal service 356 executing in the server 110. In step 2, the token renewal service 356 provides the HSM ID and the information identifying the expiring certificates to the online domain 102 via the token renewal web service 352. In step 3, the token renewal web service 352 provides this information to the data manager 114. The data manager 114 determines if a renewed certificate has already been generated and is available in the frontend database 116. If a renewed certificate is available (i.e. has already been generated), processing proceeds with step 13, described further below. If a renewed certificate is not available, processing proceeds with step 5, in which data synchronization file is downloaded from the frontend database 116 to the database management application 118. Referring to FIG. 6B, in step 6, the data synchronization file is uploaded to the backend database 120. In step 7, the offline identity generation tool generates the renewed certificate based on the information from the renewal request and saves the renewed certificates to the backend database in the synchronization file. Unlike in embodiments one, two, and three (in which only the private key is changed in the renewed certificate), in the fourth embodiment, a new public and private key pair may be generated for the renewed certificate. In step 8, the synchronization file, now including the renewed certificate, is downloaded from the backend database 120 to the database management application 118.

Again referring to FIG. 6A, in step 9, the data synchronization file with the renewed certificate is uploaded to the frontend database 116.

In step 10, the client SDK 358 again determines which certificates stored in the HSM 124 will expire according to the renewal paradigm. In step 11, the token renewal service 356 provides the HSM ID and the information identifying the expiring certificates to the online domain 102 via the token renewal web service 352 to query for the renewed certificates. The token renewal web service 352 passes this query to the data manager 114, which queries the frontend database for the renewed certificate, as shown in steps 12 and 13. In step 14, the frontend database 116 responds to the query of step 13 with the renewed certificate, which is provided to the token renewal web service in step 15. The token renewal web service 352 provides the renewed certificate to the client SDK 358 via the token renewal service 356 as shown in steps 16-17, and the client SDK 358 updates the HSM 124 with the renewed certificate as shown in step 18.

### Digital Certificate Life Cycle States

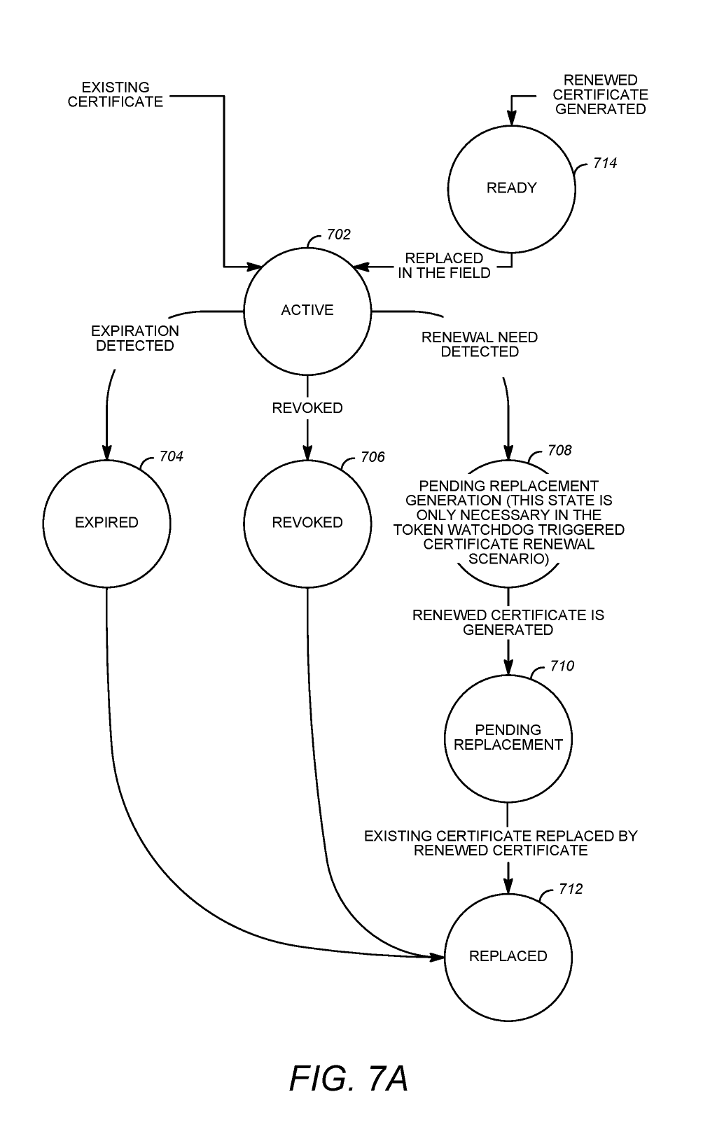

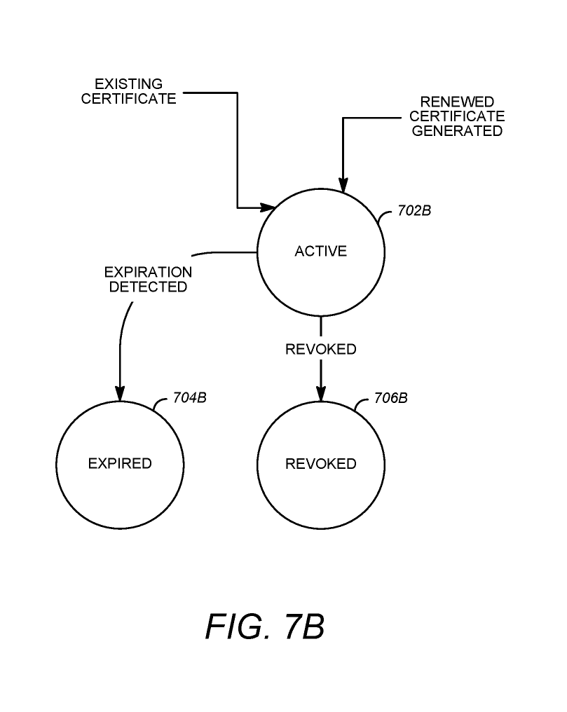

FIG. 7A is a diagram depicting a life cycle of an existing (current) digital certificate in the foregoing paradigm. State 702 reflects an active state of an existing (current) certificate installed in the HSM 124 has not expired or been revoked, for which no need for renewal has been detected (e.g. the certificate is not scheduled to expire within the time period T). State 704 is an expired state that the certificate enters if expiration is detected. Depending on the embodiment, such detection may be performed, for example, by the user 361, the client SDK 358, the token watchdog 360, or the certificate renewal request generator 350. Once replaced by a renewed certificate, the certificate enters a state of having been replaced 712.

State 706 reflects a revoked status of an existing certificate installed on the HSM 124. This status is entered if the certificate has been revoked. Again, this status may be detected by the user 361, the client SDK 358, the token watchdog 360, or the certificate renewal request generator 350. Once replaced by a renewed certificate, the certificate enters a state of having been replaced 712.

State 708 reflects a state of pending replacement generation. This state is entered in a situation a need to renew the certificate has been detected according to the renewal paradigm but before the renewed certificate has been generated. This state exists only in the third embodiment wherein the token watchdog 360 detects a need for renewal and triggers a renewed certificate generation request. This state is necessary so that the token watchdog 360 can skip those certificates in this state when considering whether a certificate should be renewed. In the third embodiment, after the renewed certificate is generated in response to the renewed certificate generation request and retrieves the newly generated renewed certificates back to its database 362, the current certificate's state becomes State 710. State 708 does not exist in the first, second and fourth embodiments, wherein a need to renewed the current certificate is detected by the user 361, the client SDK 358 or the certificate renewal request generator 350. In the first, second and fourth embodiments, after Token Renewal Service 356 sends the current and expiring certificate's renewal request to online domain 102, the current certificate's state goes from State 702 to State 710 directly. State 710 reflects a state of pending replacement. State 710 is entered when the current and expiring certificate has its renewed certificate generated but is yet to be replaced in HSM 124. Thereafter, the current certificate enters the replaced state 712.

State 714 reflects a ready state of a replacement (renewed) certificate that has been generated, but has yet to be used to replace the current certificate in the HSM 124. Once the existing certificate is replaced, the renewed certificate will be in “active” state 702.

FIG. 7B illustrates a simplified version of the life cycle of a certificate. If a PKI system does not require a fine granularity of the certificate status changes for complexity or other reasons, this version may be implemented.

State 702B reflects an active state of an existing (current) certificate installed in the HSM 124 has not expired or been revoked, for which no need for renewal has been detected (e.g. the certificate is not scheduled to expire within the time period 7). State 704B is an expired state that the certificate enters if expiration is detected. Depending on the embodiment, such detection may be performed, for example, by the user 361, the client SDK 358, the token watchdog 360, or the certificate renewal request generator 350. State 706B reflects a revoked status of an existing certificate installed on the HSM 124. This status is entered if the certificate has been revoked.

When a replacement (renewed) certificate is generated, it is given “active” status 702B. In this approach, normally there will be only one active current certificate for a HSM token. However, during a grace period when the existing (current) certificate is expiring and the new certificate is generated, there can be two certificates both active for the same HSM token. The certificate expiration date and time is used to help determine which certificate is expiring and which is the replacement in this case.

### Token Renewal Web Service and Token Renewal Application

The HSM 124 include a digital certificate used to authenticate the client workstation 108 using PKI techniques. The HSM's certificate is associated with the client workstation 108 having the client workstation IP address as the common name. The certificate is under the client domain's certificate sub certificate authority (CA) where the client workstation 108 is running. Renewed certificates are subject to the same sub CA as that expired certificates. As described above, the client certificates must be updated from time to time with new certificates so the client workstations 108 may continue to operate.

In the first embodiment described above, the token renewal application 354 executing on the client workstation 108 is used by the client workstation 108 to download and replace expiring certificates. Certificates are retrieved from the token renewal web service 352 hosted in the external portal of the online domain via the token renewal windows service 356.

The token renewal web service provides an interface to retrieve the renewed certificates using input parameters including the HSM ID and IP address or the original certificate which is to be replaced, and retrieves the renewed certificate from the frontend (PKI system) database 116 using the HSM ID and the IP address.

The token renewal web service 352 validates the renewed certificate using the original certificate. Such validation can be more easily accomplished by assuring that (1) the subject name of the renewed certificate is the same as that of the original certificate (2) the public key of the renewed certificate is the same as that of the original certificate (only the private key is changed in the renewed certificate), (3) the sub CA of the renewed certificate is the same sub CA of the original certificate, and (4) the valid start date of the renewed certificate is newer than that of the original certificate. The token renewal web service 352 logs parameters for each call to retrieve a new certificate from the frontend database 116, including the HSM ID, the certificate's common name (IP address), a status of retrieving a renewed certificate.

The token renewal application 354 presents an interface on the client workstation 108 for display that includes the HSM ID, the current certificate's common name, the sub CA certificate's common name (location name of the client domain), and the current certificate's validity. The token renewal application 354 retrieves renewed certificates from the token renewal web service 352 via the token renewal service 356 using the HSM ID and the original certificate to be replaced. The token renewal application 354 validates the renewed certificate by assuring that (1) the renewed certificate's valid start date is newer than the original certificate's start date (2) the common name (IP Address) is the same and the original certificate's common name (3) the new certificate shall chain to the same sub CA and root certificate as the original one and (4) the private key is used to sign data blob and verified with downloaded certificate's public key. Once validated, the token renewal application 354 replaces the original certificate with the renewed certificate. In one embodiment, the token renewal application 354 also validates that the replacement with the renewed certificate was successful by verifying that new certificate can be used to retrieve information and that the private key was used to sign the data blob and verified with the retrieved certificate's public key. The token renewal application 354 also sends the status of the certificate update process to the token renewal web service 352.

In embodiment involving user interaction (e.g. the first embodiment), the token renewal web service 352 and token renewal application 354 operate as follows. The user plugs the HSM 124 into the client workstation 108, and executes the token renewal application 354. The token renewal application 354 detects the HSM 124 and displays the HSM 124 detection status. In one embodiment, the token renewal application enforces a rule that only one HSM 124 be used at a time. The token renewal application 354 then retrieves the HSM ID and the certificate to be renewed. The application then displays the HSM ID and IP address, and waits for the user to confirm to update. When the user confirms the process, the token renewal application 354 sends the serial number and the certificate to be renewed to the token renewal web service 352. The token renewal web service transmits a response that is received by the token renewal application 354. The token renewal application 354 validates the renewed certificate (using the techniques described above), renames the old certificate's label, inserts the renewed certificate to the HSM 124 with the original old certificate's label, retrieves the newly inserted certificate and verify the newly inserted certificate with the private key. When this process is complete, the token renewal application 354 deletes the old certificate, sends UPDATE COMPLETED message to token renewal web service, and informs the user the token has been updated with the latest certificate.

### Client SDK

As described above, the HSM 124 and stored certificate allows the client workstation 108 to connect to the server 110. The client SDK 358 comprises a SDK library 358A having a library of functions and a SDK application 358B that interfaces with the SDK library and provides SDK function commands to permit the client workstation 108 and the server 110 to send and receive messages from one another.

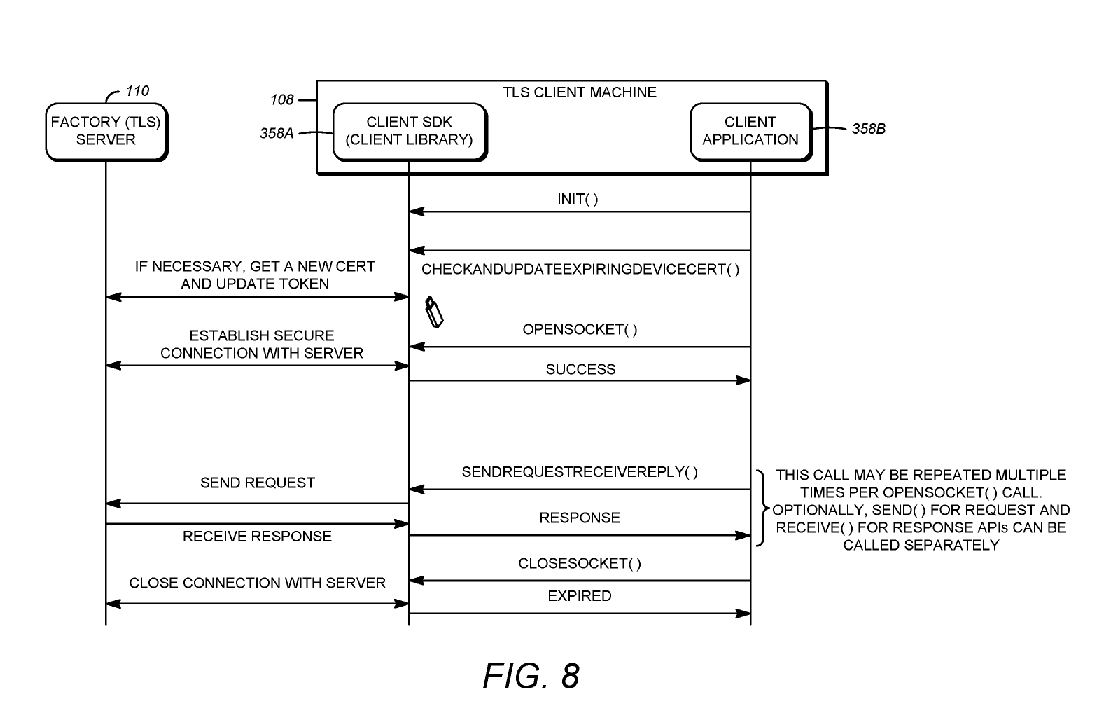

FIG. 8 is a sequence diagram describing the operation of the client SDK 358 in the requesting of renewed (updated) digital certificates. The SDK application 358B invokes an Init function of the SDK library 358 to initialize the HSM 124 and its internal objects. The SDK application 358B can also invoke a CheckAndUpdateExpiringDeviceCert function, which checks if the device signing certificate (the aforementioned current digital certificate) is expired or if it is going to expire within a period of time (e.g. three months). If this condition is true, the client SDK 358 and the server 110 work together to download a renewed digital certificate and will replace the existing digital certificate as described above. Otherwise, no action is taken.

The OpenSocket function creates a secure connection with the server 110 using the IP address and port number to indicate which server to connect to.

The SendRequestReceiveReply function invokes the client SDK to send a request to the server 110 via the Send function, and to receives a response back from the server 110 via the Receive function.

The CloseSocket function closes the connection with the server 110.

### Hardware Environment

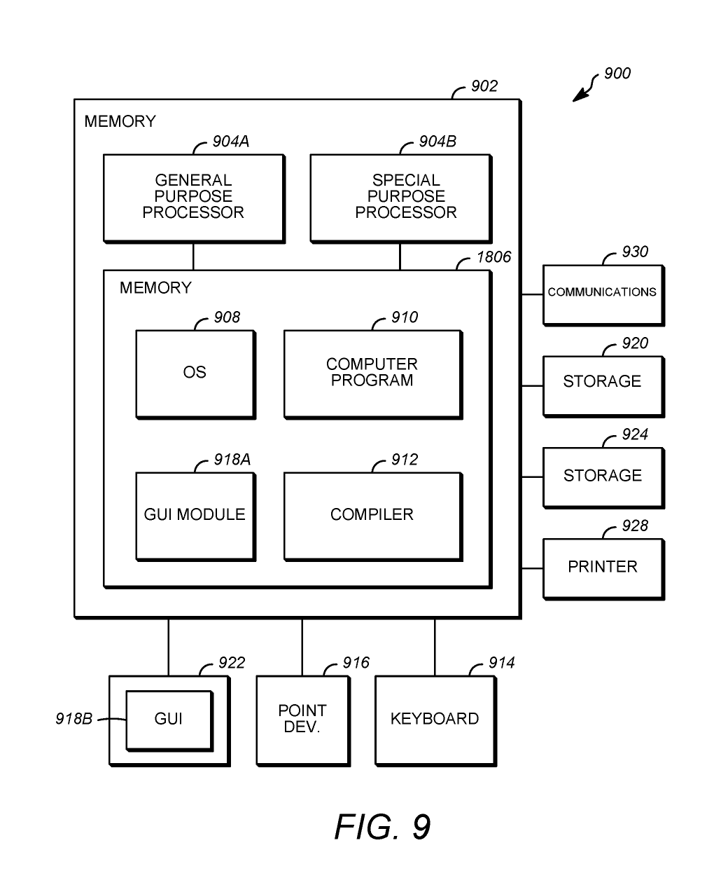

FIG. 9 is a diagram illustrating an exemplary computer system 900 that could be used to implement elements of the present invention, including the client workstation 108 and server 110 of the client domain 106, the external portal 112, data manager 114, and data management application 118 of the online domain 102, and the offline identity data generation tool 122 of the offline domain 104. The computer 902 comprises a general purpose hardware processor 904A and/or a special purpose hardware processor 904B (hereinafter alternatively collectively referred to as processor 904) and a memory 906, such as random access memory (RAM). The computer 902 may be coupled to other devices, including input/output (I/O) devices such as a keyboard 914, a mouse device 916 and a printer 928.

In one embodiment, the computer 902 operates by the general purpose processor 904A performing processor instructions defined by the computer program 910 under control of an operating system 908. The computer program 910 and/or the operating system 908 may be stored in the memory 906 and may interface with the user and/or other devices to accept input and commands and, based on such input and commands and the instructions defined by the computer program 910 and operating system 908 to provide output and results.

Output/results may be presented on the display 922 or provided to another device for presentation or further processing or action. In one embodiment, the display 922 comprises a liquid crystal display (LCD) having a plurality of separately addressable pixels formed by liquid crystals. Each pixel of the display 922 changes to an opaque or translucent state to form a part of the image on the display in response to the data or information generated by the processor 904 from the application of the instructions of the computer program 910 and/or operating system 908 to the input and commands. Other display 922 types also include picture elements that change state in order to create the image presented on the display 922. The image may be provided through a graphical user interface (GUI) module 918A. Although the GUI module 918A is depicted as a separate module, the instructions performing the GUI functions can be resident or distributed in the operating system 908, the computer program 910, or implemented with special purpose memory and processors.

Some or all of the operations performed by the computer 902 according to the computer program 910 instructions may be implemented in a special purpose processor 904B. In this embodiment, some or all of the computer program 910 instructions may be implemented via firmware instructions stored in a read only memory (ROM), a programmable read only memory (PROM) or flash memory within the special purpose processor 904B or in memory 906. The special purpose processor 904B may also be hardwired through circuit design to perform some or all of the operations to implement the present invention. Further, the special purpose processor 904B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 902 may also implement a compiler 912 which allows an application program 910 written in a programming language such as COBOL, C++, FORTRAN, or other language to be translated into processor 904 readable code. After completion, the application or computer program 910 accesses and manipulates data accepted from I/O devices and stored in the memory 906 of the computer 902 using the relationships and logic that was generated using the compiler 912.

The computer 902 also optionally comprises an external communication device such as a modem, satellite link, Ethernet card, or other device for accepting input from and providing output to other computers.

In one embodiment, instructions implementing the operating system 908, the computer program 910, and/or the compiler 912 are tangibly embodied in a computer-readable medium, e.g., data storage device 920, which could include one or more fixed or removable data storage devices, such as a zip drive, floppy disc drive 924, hard drive, CD-ROM drive, tape drive, or a flash drive. Further, the operating system 908 and the computer program 910 are comprised of computer program instructions which, when accessed, read and executed by the computer 902, causes the computer 902 to perform the steps necessary to implement and/or use the present invention or to load the program of instructions into a memory, thus creating a special purpose data structure causing the computer to operate as a specially programmed computer executing the method steps described herein. Computer program 910 and/or operating instructions may also be tangibly embodied in memory 906 and/or data communications devices 930, thereby making a computer program product or article of manufacture according to the invention. As such, the terms “article of manufacture,” “program storage device” and “computer program product” or “computer readable storage device” as used herein are intended to encompass a computer program accessible from any computer readable device or media.

Of course, those skilled in the art will recognize that any combination of the above components, or any number of different components, peripherals, and other devices, may be used with the computer 902.

Although the term “computer” is referred to herein, it is understood that the computer may include portable devices such as cellphones, portable MP3 players, video game consoles, notebook computers, pocket computers, or any other device with suitable processing, communication, and input/output capability.

### CONCLUSION

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching.

It is intended that the scope of the invention be limited not by this detailed description, but rather by the claims appended hereto. The above specification, examples and data provide a complete description of the manufacture and use of the apparatus and method of the invention. Since many embodiments of the invention can be made without departing from the scope of the invention, the invention resides in the claims hereinafter appended.

What is claimed is:

1. In a system comprising an online domain, an offline domain and a client domain, a method of remotely renewing at least one of a subset of a plurality of digital certificates stored in a hardware security module (HSM) in the client domain, comprising:
generating a certificate renewal request comprising a request for at least one renewed digital certificate according to a renewal paradigm in which the at least one renewed digital certificate is generated before the at least one of the digital certificates expires;
providing the certificate renewal request to the offline domain;
obtaining, in the online domain from the offline domain, the at least one renewed digital certificate; and
transmitting the at least one renewed digital certificate to the client domain for storage in the HSM in place of the at least one of the subset of the plurality of digital certificates.

2. The method of claim 1, wherein:
the at least one renewed certificate comprises a same subject name as that of the one of the subset of the plurality of digital certificates replaced by the at least one renewed certificate; and
the at least one renewed certificate comprises a same public key as that of the one of the subset of the plurality of digital certificates replaced by the at least one renewed digital certificate.

3. The method of claim 2, wherein:
the at least one renewed certificate is subject to a same sub certificate authority as that of the one of the subset of the plurality of digital certificates replaced by the at least one renewed digital certificate.

4. The method of claim 1, wherein:
the certificate renewal request is generated in the online domain by a certificate request generator and transmitted to the offline domain;
the renewal paradigm comprises renewing certificates having a temporal range of expiration dates;
the certificate renewal request comprises information describing which of the plurality of digital certificates need to be renewed according to the renewal paradigm;
providing the certificate renewal request to the offline domain comprises:
accepting the certification renewal request in a database management application of the online domain;
downloading a data synchronization file from a frontend database of the online domain; and
uploading data synchronization file to a backend database of the offline domain;
obtaining, in the online domain from the offline domain, the at least one renewed digital certificate comprises:
generating the at least one renewed digital certificate in the offline domain; and
downloading the data synchronization file including the at least one renewed digital certificate to the frontend database via the database management application; and
transmitting the at least one renewed digital certificate to the client domain comprises:
transmitting a notification from the database management application to a human user of the HSM in the client domain, the notification triggering renewal of the at least one digital certificate of the subset of the plurality of digital certificates with the at least one renewed digital certificate.

5. The method of claim 1, wherein:
the certificate renewal request is generated in the online domain by a certificate request generator and transmitted to the offline domain;
the renewal paradigm comprises renewing certificates having a temporal range of expiration dates;
the certificate renewal request comprises information describing which of the plurality of digital certificates need to be renewed according to the renewal paradigm;
providing the certificate renewal request to the offline domain comprises:
accepting the certification renewal request in a database management application of the online domain;
downloading a data synchronization file from a frontend database of the online domain; and
uploading data synchronization file to a backend database of the offline domain.
obtaining, in the online domain from the offline domain, the at least one renewed digital certificate comprises:
generating the at least one renewed digital certificate in the offline domain according to the renewal paradigm; and
downloading the data synchronization file modified to include the at least one renewed digital certificate to the frontend database via the database management application; and
the HSM is communicatively coupleable to a processor executing a client communication application; and
transmitting the at least one renewed digital certificate to the client domain comprises:
providing the at least one renewed digital certificate to the HSM, comprising:
receiving a renewed certificate request comprising an identifier of the HSM;
querying the frontend database for the at least one renewed digital certificate associated with the identifier of the HSM;
receiving the at least one renewed digital certificate associated with the identifier of the HSM from the frontend database; and
transmitting the at least one renewed digital certificate associated with the identifier of the HSM to the HSM.

6. The method of claim 5, wherein:
the renewed certificate request is received in response to an automatic determination, by the client communication application executing in the client domain, that renewal of the at least one digital certificate is required according to the renewal paradigm.

7. The method of claim 5, wherein:
the client communication application sets up and maintains secure communications between the client communication application executing on a client workstation and a server using security objects stored in the HSM;
receiving the renewed certificate request comprising the identifier of the HSM comprises:
transmitting a message to the server requesting the at least one renewed digital certificate, the message comprising an IP address of a client workstation and the identifier of the HSM; and
transmitting the IP address of the client workstation and the identifier of the HSM to a token renewal web service of the online domain.

8. The method of claim 1, wherein:
the certificate renewal request is generated in the client domain by a server executing a token watchdog application periodically querying a token watchdog database of digital certificates according to the renewal paradigm, the server communicatively coupled to a client workstation having the HSM and executing a client communication application for setting up and maintaining secure communications between the client workstation and the server using security objects stored in the HSM;
providing the certificate renewal request to the offline domain comprises:
accepting the certificate renewal request in a database management application of the online domain from the server;
downloading a data synchronization file from a frontend database of the online domain; and
uploading data synchronization file to a backend database of the offline domain;
obtaining, in the online domain from the offline domain, the at least one renewed digital certificate comprises:
generating the at least one renewed digital certificate in the offline domain; and
downloading the data synchronization file modified to include the at least one renewed digital certificate to the frontend database via the database management application; and
transmitting the at least one renewed digital certificate to the client domain comprises providing the at least one renewed digital certificate to the HSM, comprising:
transmitting, from the online domain, the at least one renewed digital certificate to the token watchdog application for storage in the token watchdog database of digital certificates, comprising:
receiving a request for the at least one renewed digital certificate from the token watchdog application;
querying the frontend database for the at least one renewed digital certificate;
receiving the at least one renewed digital certificate the frontend database; and
transmitting the at least one renewed digital certificate to the token watchdog application for storage in the HSM.
wherein the at least one renewed digital certificate is retrieved from the token watchdog database via the token watchdog application and stored in the HSM by the client communication application automatically and without user intervention.

9. The method of claim 8, wherein the certificate renewal request is accepted in the database management application via a token renewal web service in the online domain.

10. The method of claim 1, wherein:
the certificate renewal request is generated by a client communication application for setting up and maintaining secure communications between a client work station and a server using security objects stored in the HSM;
the certificate renewal request comprises information describing which of the plurality of certificates need to be renewed according to the renewal paradigm and an identifier of the HSM;
providing the certificate renewal request to the offline domain comprises:
accepting the certificate renewal request in a database management application of the online domain from the server, the certificate renewal request comprising an identifier of the HSM;
downloading a data synchronization file from a frontend database of the online domain; and
uploading the data synchronization file to a backend database of the offline domain; and
obtaining, from in the offline domain, the at least one renewed digital certificate comprises:
downloading the data synchronization file including the at least one renewed digital certificate from the backend database of the offline domain, the at least one renewed digital certificate generated by an offline identity data generation tool;
transmitting the at least one renewed digital certificate to the client domain comprises:
providing the at least one renewed digital certificate to the HSM, comprising:
receiving a renewed certificate request comprising an identifier of the HSM;
querying the frontend database for the at least one renewed digital certificate associated with the identifier of the HSM;
receiving the at least one renewed digital certificate associated with the identifier of the HSM from the frontend database; and
transmitting the at least one renewed digital certificate associated with the identifier of the HSM to the HSM.

11. The method of claim 10, wherein:
the renewed certificate request is received in response to an automatic determination, by the client communication application executing in the client domain, that renewal of the at least one digital certificate is required according to the renewal paradigm.

12. In a system comprising an online domain, an offline domain and a client domain, an apparatus for remotely renewing at least one of a subset of a plurality of digital certificates stored in a hardware security module (HSM) in the client domain, comprising:
means for generating a certificate renewal request comprising a request for at least one renewed digital certificate according to a renewal paradigm in which the at least one renewed digital certificate is generated before the at least one of the digital certificates expires;
means for providing the certificate renewal request to the offline domain;
means for obtaining, in the online domain from the offline domain, the at least one renewed digital certificate; and
means for transmitting the at least one renewed digital certificate to the client domain for storage in the HSM in place of the at least one of the subset of the plurality of digital certificates.

13. The apparatus of claim 12, wherein:
the at least one renewed certificate comprises a same subject name as that of the one of the subset of the plurality of digital certificates replaced by the at least one renewed certificate; and
the at least one renewed certificate comprises a same public key as that of the one of the subset of the plurality of digital certificates replaced by the at least one renewed digital certificate.

14. The apparatus of claim 13, wherein:
the at least one renewed certificate is subject to a same sub certificate authority as that of the one of the subset of the plurality of digital certificates replaced by the at least one renewed digital certificate.

15. The apparatus of claim 12, wherein:
the means for generating the certificate renewal request comprises a certificate request generator and the certificate renewal generator transmits the certificate renewal request to the offline domain, the renewal paradigm comprising renewing certificates having a temporal range of expiration dates and the certificate renewal request comprising information describing which of the plurality of digital certificates need to be renewed according to the renewal paradigm;
the online domain comprises a database management application, the database management application comprising:
means for accepting the certificate renewal request;
means for downloading a data synchronization file from a frontend database of the online domain; and
means for uploading data synchronization file to a backend database of the offline domain;
means for downloading the data synchronization file including an at least one renewed digital certificate to the frontend database;
the means for obtaining, in the online domain from the offline domain, the at least one renewed digital certificate comprises:
an offline identity generation tool for generating the at least one renewed digital certificate in the offline domain; and
the means for transmitting the at least one renewed digital certificate to the client domain comprises:
means for transmitting a notification from the database management application to a human user of the HSM in the client domain, the notification triggering renewal of the at least one digital certificate of the subset of the plurality of digital certificates with the at least one renewed digital certificate.

16. The apparatus of claim 15, wherein:
the means for generating the certificate renewal request comprises a certificate request generator and the certificate renewal generator transmits the certificate renewal request to the offline domain, the renewal paradigm comprising a temporal range of expiration dates of the plurality of digital certificates and the certificate renewal request comprising information describing which of the plurality of digital certificates need to be renewed according to the renewal paradigm;
the online domain comprises a database management application, the database management application comprising:
means for accepting the certificate renewal request;
means for downloading a data synchronization file from a frontend database of the online domain; and
means for uploading data synchronization file to a backend database of the offline domain;
means for downloading the data synchronization file including the at least one renewed digital certificate to the frontend database;
the means for obtaining, in the online domain from the offline domain, the at least one renewed digital certificate comprises:
an offline identity generation tool for generating the at least one renewed digital certificate in the offline domain; and
the HSM is communicatively coupleable to a processor executing a client communication application and the means for transmitting the at least one renewed digital certificate to the client domain comprises:
means for providing the at least one renewed digital certificate to the HSM, comprising:
a means for receiving a renewed certificate request comprising an identifier of the HSM;
a data manager, for querying the frontend database for the at least one renewed digital certificate associated with the identifier of the HSM and for receiving the at least one renewed digital certificate associated with the identifier of the HSM from the frontend database; and
a token web renewal service for transmitting the at least one renewed digital certificate associated with the identifier of the HSM to the HSM.

17. The apparatus of claim 16, wherein:
the renewed certificate request is received in response to an automatic determination, by the client communication application executing in the client domain, that renewal of the at least one digital certificate is required according to the renewal paradigm.

18. The apparatus of claim 16, wherein:
the client communication application sets up and maintains secure communications between the client communication application and a server using security objects stored in the HSM;
the means for receiving the renewed certificate request comprising the identifier of the HSM comprises:
the client communication application, transmitting a message to the server requesting the at least one renewed digital certificate, the message comprising an IP address of a client workstation and the identifier of the HSM; and
a token renewal service, executing on the server, for transmitting the IP address of the client workstation and the identifier of the HSM to a token renewal web service of the online domain.

19. The apparatus of claim 12, wherein:
the means for generating the certificate renewal request comprises a token watchdog application executing on a server and periodically querying a token watchdog database of digital certificates according to the renewal paradigm, the server communicatively coupled to a client workstation having the HSM and executing a client communication application for setting up and maintaining secure communications between the client workstation and the server using security objects stored in the HSM;
the means for providing the certificate renewal request to the offline domain comprises a database management application, comprising:
means for accepting the certificate renewal request in a database management application of the online domain from the server;
means for downloading a data synchronization file from a frontend database of the online domain; and
means for uploading data synchronization file to a backend database of the offline domain;
means for downloading the data synchronization file modified to include the at least one renewed digital certificate to the frontend database via the database management application; and
the means for obtaining, in the online domain from the offline domain, the at least one renewed digital certificate comprises:
an offline identity generation tool for generating the at least one renewed digital certificate in the offline domain; and
the means for transmitting the at least one renewed digital certificate to the client domain comprises means for providing the at least one renewed digital certificate to the HSM, comprising:
a token renewal web service for transmitting, from the online domain, the at least one renewed digital certificate to the token watchdog application for storage in the token watchdog database of digital certificates, comprising:
means for receiving a request for the at least one renewed digital certificate from the token watchdog application;
a data manager for querying the frontend database for the at least one renewed digital certificate, and for receiving the at least one renewed digital certificate the frontend database; and
means for transmitting the at least one renewed digital certificate to the token watchdog application for storage in the HSM.
wherein the at least one renewed digital certificate is retrieved from the token watchdog database via the token watchdog application and stored in the HSM by the client communication application automatically and without user intervention.

20. The apparatus of claim 19, wherein the certificate renewal request is accepted in the database management application via a token renewal web service in the online domain.
